(19) United States
(12) Patent Application Publication
(10) Pub. No.: US 2005/0231428 A1
(43) Pub. Date: Oct. 20, 2005

(54) Portable radio

(75) Inventors: Akihiko Iguchi, Osaka (JP); Misako Sakae, Osaka (JP); Yuki Satoh, Osaka (JP)

Correspondence Address: PARKHURST & WENDEL, L.L.P., 1421 PRINCE STREET, SUITE 210, ALEXANDRIA, VA, 22314-2805, US

(73) Assignee: Matsushita Elec. Ind. Co., Ltd., Kadoma (JP)

(21) Appl. No.: 10/519,361

(22) PCT Filed: Jul. 1, 2004
(86) PCT No.: PCT/JP04/09688

§ 371 Date: Dec. 28, 2004

(30) Foreign Application Priority Data
Jul. 8, 2003 (JP) 2003-193425

(51) Int. Cl. H01Q 1/24

(52) U.S. Cl. 343/702

(57) ABSTRACT

The present invention provides a portable transceiver where a broadband of an antenna characteristic can be realized and efficiency is improved. The present invention provides a portable transceiver includes a first housing (7) having a first circuit board (5) in its inside and an input section at its surface, a second housing (8) having a second circuit board (6) in its inside and a display section at its surface, and a coupling section (4) for electrically coupling the first circuit board (5) with the second circuit board (6). An antenna section (3) and an element section (9) are disposed at one of the circuit boards, and the first housing (7) and the second housing (9) are coupled with each other via a hinge section (2) and can be folded.

### TECHNICAL FIELD

The present invention relates to a portable transceiver such as a portable telephone.

### BACKGROUND ART

Recently a built-in antenna has been commonly used in a field of a radio communication device, particularly a portable transceiver.

A perspective view of a conventional folding portable transceiver is shown in FIG. 9.

Built-in antenna section 103 is disposed near hinge section 102 and close to coupling section 104. Keyboard side board 105, which is a first circuit board, is coupled with liquid crystal display side board 106, which is a second circuit board, via coupling section 104. Keyboard side board 105 is covered with first housing 107 having an input section at its surface. Liquid crystal display side board 106 is covered with second housing 108 having a display section.

An example of the portable transceiver having the structure mentioned above is disclosed in Japanese Patent Unexamined Publication No. 2003-8320.

In a case of built-in antenna section 103 disposed near hinge section 102 shown in FIG. 9, when portable transceiver 101 is opened and shut, an input impedance of built-in antenna section 103 changes.

In particular, when portable transceiver 101 is shut, current distribution concentrates and an impedance characteristic deteriorates because built-in antenna section 103 is close to coupling section 104. Therefore, it is difficult to work at a broadband.

The present invention provides a portable transceiver where a broadband of an antenna characteristic can be realized and efficiency is improved.

### SUMMARY OF THE INVENTION

The present invention provides a portable transceiver includes the following elements: a first housing having a first circuit board in its inside and an input section at its surface; a second housing having a second circuit board in its inside and a display section at its surface; a coupling section for electrically coupling the first circuit board with the second circuit board; a hinge section for coupling the first housing with the second housing and capable of folding them. An antenna section and an element section are disposed at one of the first circuit board and the second circuit board.

### BRIEF DESCRIPTION OF THE DRAWINGS

FIG. 1 is a perspective view of a portable transceiver in accordance with a first exemplary embodiment of the present invention.

FIG. 2 shows a VSWR characteristic of the portable transceiver in accordance with the first exemplary embodiment of the present invention.

FIG. 3 shows a VSWR characteristic of a conventional portable transceiver.

FIG. 4 is a perspective view of a portable transceiver in accordance with a second exemplary embodiment of the present invention.

FIG. 5 is a perspective view of an antenna section in accordance with a third exemplary embodiment of the present invention.

FIG. 6 is a perspective view of an antenna section in accordance with a fourth exemplary embodiment of the present invention.

FIG. 7 is a perspective view of a portable transceiver in accordance with a fifth exemplary embodiment of the present invention.

FIG. 8 is a perspective view of an element section in accordance with a sixth exemplary embodiment of the present invention.

FIG. 9 is a perspective view of a conventional portable transceiver.

### DETAILED DESCRIPTION OF PREFERRED EMBODIMENTS

Exemplary embodiments of the present invention are demonstrated hereinafter with reference to the accompanying drawings and it is emphasized that the drawings do not show actual dimensional relations between respective elements. In the description, the same elements are denoted with the same reference marks, and the descriptions of those elements are omitted.

### First Exemplary Embodiment

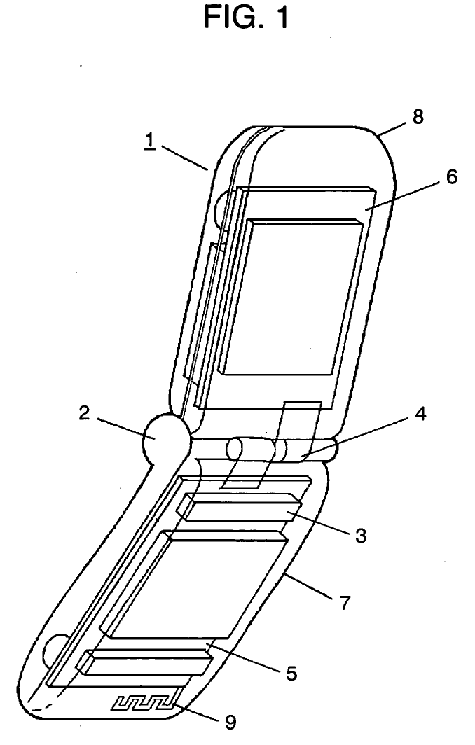

The first embodiment of the present invention is described hereinafter with reference to FIG. 1.

Antenna section 3 of openable and closable portable transceiver 1 is disposed near hinge section 2 and close to coupling section 4.

Keyboard side board 5, which is a first circuit board, is coupled with liquid crystal display side board 6, which is a second circuit board, via coupling section 4. Keyboard side board 5 is covered with first housing 7 having an input section at its surface. Liquid crystal display side board 6 is covered with second housing 8 having a display section. Element section 9 is coupled with a ground which is opposite antenna section 3 at keyboard side board 5 and formed at an end side of the board, and formed of a meander shaped metal plate.

Next, characteristics of portable transceiver 1 of the present embodiment are described hereinafter.

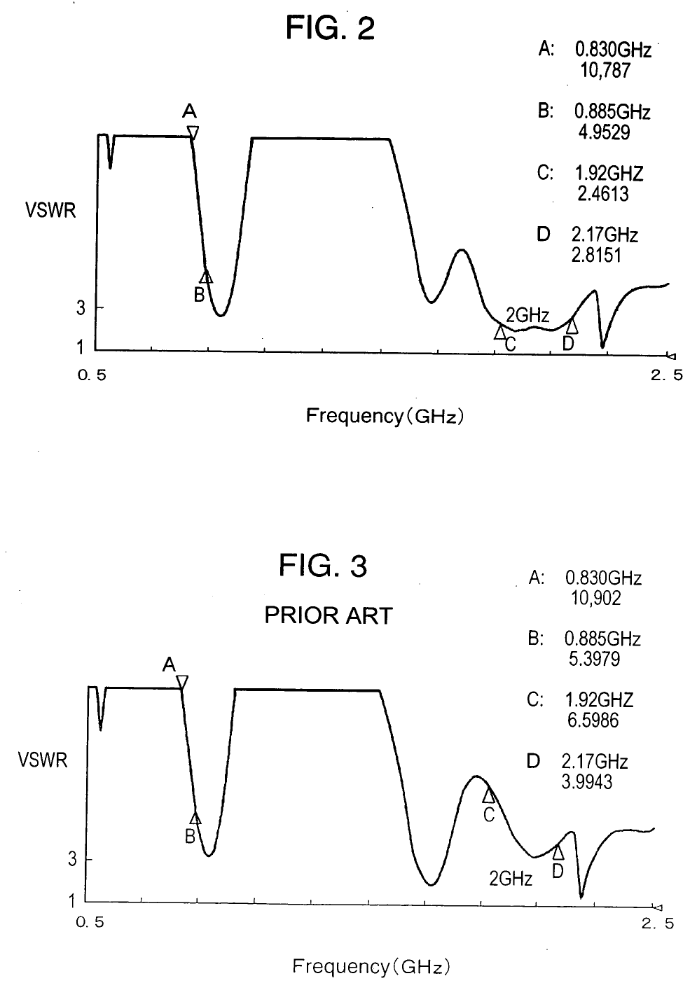

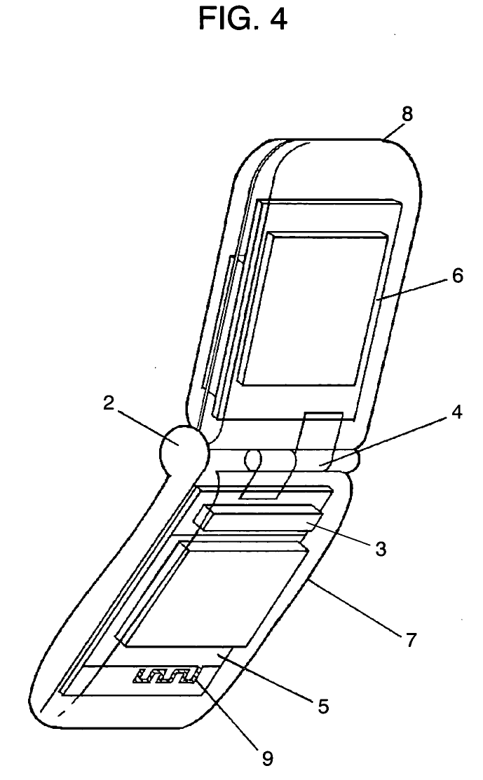

A Voltage Standing Wave Ratio characteristic (hereinafter referred to as “VSWR characteristic”) of the present structure adding element section 9 is shown in FIG. 2. A VSWR characteristic without adding element section 9 is shown in FIG. 3.

Point “A”, “B”, “C” and “D” in FIGS. 2-3 respectively show VSWRs of frequencies of 0.830 GHz, 0.885 GHz, 1.92 GHz and 2.17 GHz. For example, VSWR is 2.4613 at “C” point (1.92 GHz) in FIG. 2. As shown in FIG. 2, the VSWR characteristic approaches 1 at 2 GHz band. Frequency bands whose VSWR characteristics are less than 3 are approximately 300 MHz (i.e., a range between points “C” and “D”).

This shows that radio frequency power from the circuit board side is efficiently supplied to the antenna side.

As a result, using the structure discussed above, a broadband can be realized at 2 GHz band. On the other hand, as shown in FIG. 3, in a case where element section 9 is not formed, frequency bands whose VSWR characteristics are less than 3 can not be obtained at 2 GHz band. In a word, a broadband can not be realized.

As discussed above, a broadband can be realized by forming antenna section 3 disposed close to coupling section 4 and element section 9, which is opposite antenna section 3, formed at an end side of the board, and coupled with a ground. The reason the broadband can be realized is that current distribution, which has concentrated on antenna section 3 and coupling section 4, is dispersed at a side of element section 9, so that an input impedance of antenna section 3 can be high impedance. At this time, in order to produce resonance, element section 9 is formed in length to be approximately half wavelength of a desirable frequency.

In a word, a length of element section 9 is structured so that an electrical length becomes λ/2, where λ denotes a wavelength of the desirable frequency which produces resonance.

### Second Exemplary Embodiment

The second embodiment of the present invention is described hereinafter with reference to FIG. 4.

Antenna section 3 is disposed near hinge section 2 and close to coupling section 4. Keyboard side board 5, which is a first circuit board, is coupled with liquid crystal display side board 6, which is a second circuit board, via coupling section 4. Keyboard side board 5 is covered with first housing 7 having an input section at its surface. Liquid crystal display side board 6 is covered with second housing 8 having a display section. Element section 9 is formed of a pattern on the board, where the pattern is extended from a ground pattern of keyboard side board 5.

By using the pattern on the board discussed above, the same effect can be obtained as the case where the metal plate is used. In addition, costs can be cut down because element section 9 is formed of the pattern on the board.

### Third Exemplary Embodiment

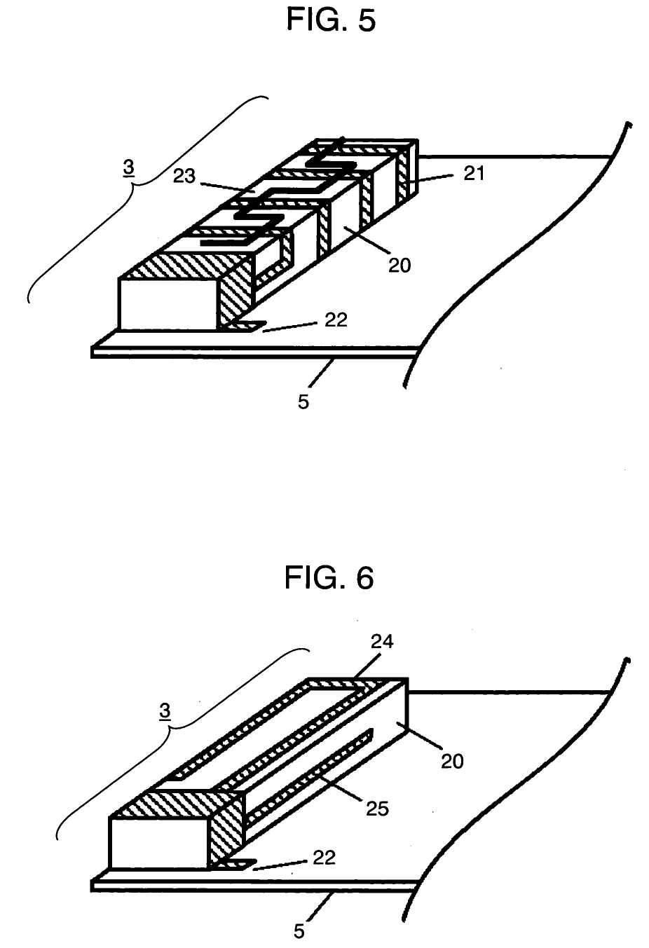

The third embodiment of the present invention is described hereinafter with reference to FIG. 5.

FIG. 5 is an enlarged view of an example of antenna section 3 of FIG. 1.

Antenna section 3 is formed of helical element 21, feeding section 22 and meander element 23. Electric power is supplied to helical element 21, feeding section 22 is coupled with a power supply terminal on resin substrate 20, and meander element 23 is insulated from helical element 21.

As discussed above, antenna section 3 is formed of a plurality of elements including helical element 21 and meander element 23.

As a result, antenna section 3 can treat a plurality of frequency bands corresponding to respective elements.

In a word, a portable transceiver having a broad band characteristic can be provided at a frequency band corresponding to any one of elements.

### Fourth Exemplary Embodiment

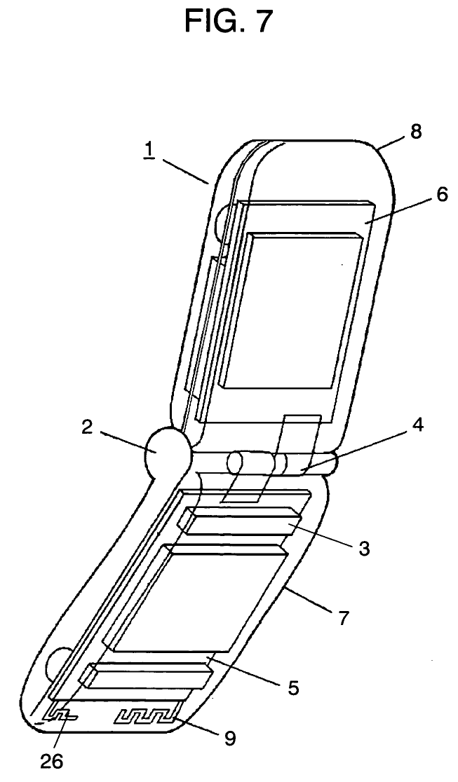

The fourth embodiment of the present invention is described hereinafter with reference to FIG. 6.

FIG. 6 is an enlarged view of another example of antenna section 3 of FIG. 1.

Antenna section 3 is formed of first folding type element 24, feeding section 22 and second element 25. Electric power is supplied to first folding type element 24, feeding section 22 is coupled with a power supply terminal on resin substrate 20, and second element 25 is coupled with first folding type element 24.

As discussed above, antenna section 3 is formed of a plurality of elements including first folding type element 24 and second folding type element 25.

As a result, antenna section 3 can treat a plurality of frequency bands corresponding to respective elements.

In a word, a portable transceiver having a broad band characteristic can be provided at a frequency band corresponding to any one of elements.

### Fifth Exemplary Embodiment

The fifth embodiment of the present invention is described hereinafter with reference to FIG. 7.

Antenna section 3 in FIG. 7 is formed of first folding type element 24, to which electric power is supplied, shown in FIG. 6 and second element 25 coupled therewith. Antenna section 3 is disposed near hinge section 2 and close to coupling section 4.

Keyboard side board 5, which is a first circuit board, is coupled with liquid crystal display side board 6, which is a second circuit board, via coupling section 4.

Keyboard side board 5 is covered with first housing 7 having an input section at its surface. Liquid crystal display side board 6 is covered with second housing 8 having a display section. First element section 9 and second element section 26 each is formed of a meander shaped metal plate. They are coupled with a ground which is opposite antenna section 3 at keyboard side board 5 and formed at an end side of the board.

Using the structure discussed above, first element section 9 corresponds to a first frequency band and second element section 26 corresponds to a second frequency band, so that each current distribution concentrates. Therefore, a broad band can be realized at a plurality of frequency bands. Thus, a portable transceiver having such a characteristic can be provided.

### Sixth Exemplary Embodiment

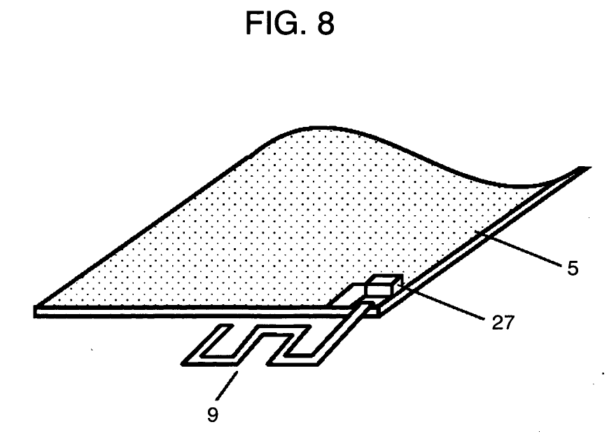

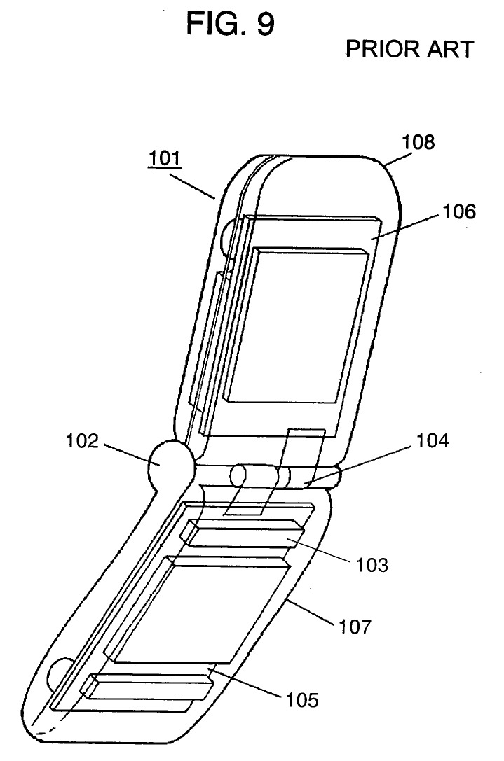

The sixth embodiment of the present invention is described hereinafter with reference to FIG. 8.

First element section 9 is formed of a meander shaped metal plate and coupled with a ground, which is opposite antenna section 3 at keyboard side board 5 and formed at an end side of the board, via inductance section 27.

As discussed above, a length of an element section can be shortened by coupling via inductance section 27, so that the element section can be miniaturized. A chip coil or the like can be used as the inductance section.

The present invention provides a portable transceiver includes a first housing having a first circuit board in its inside and an input section at its surface, a second housing having a second circuit board in its inside and a display section at its surface, and a coupling section for electrically coupling the first circuit board with the second circuit board. In addition, an antenna section and an element section are disposed at one of the first circuit board and the second circuit board. Besides, the first housing and the second housing are coupled with each other via a hinge section to be folded. By using the structure mentioned above, electric currents concentrate on the element section, so that an input impedance of an antenna can be a broad band.

Further, in the present invention, the antenna section and the element section may be respectively disposed near two sides, which are opposite to each other, of the circuit board. In this case, electric currents can concentrate on the element section, and an input impedance of the antenna can be a broad band.

Still further, in the present invention, the element section may be formed of a pattern on the circuit board. In this case, electric currents can concentrate on the element section, and an input impedance of the antenna can be a broad band.

Yet further, in the present invention, the element section is formed of a metal plate. In this case, electric currents can concentrate on the element section, and an input impedance of the antenna can be a broad band.

Furthermore, in the present invention, a length of the element section may be an electrical length of λ/2. In this case, electric currents can concentrate on the element section, and an input impedance of the antenna can be a broad band.

In the present invention, the antenna section may be formed of the helical element and the meander element. In this case, electric currents can concentrate on the element section, and an input impedance of the antenna can be a broad band.

In the present invention, the antenna section may be formed of a plurality of folding type elements to which electric power is supplied. In this case, electric currents can concentrate on the element section, and an input impedance of the antenna can be a broad band.

In the present invention, a plurality of element sections may be formed. In this case, electric currents can concentrate on the plurality of element sections, and an input impedance of the antenna can be a broad band at a plurality of frequency bands.

In the present invention, the element section and the coupling section of the circuit board may be coupled with each other via the inductance section. In this case, electric currents can concentrate on the element section, and an input impedance of the antenna can be a broad band.

As discussed above, the present invention provides a portable transceiver includes two circuit boards and the coupling section for electrically coupling them. The antenna section and the element section are disposed at one of the circuit boards, and two housing are coupled with each other via the hinge section and can be folded. Using the structure discussed above, the portable transceiver having a broad band characteristic can be provided.

### INDUSTRIAL APPLICABILITY

An antenna of the present invention can be incorporated in a portable transceiver, which requires a broad band, and widely applied.

1. A portable transceiver comprising:
a first housing having a first circuit board in its inside and an input section at its surface;
a second housing having a second circuit board in its inside and a display section at its surface;
a coupling section for electrically coupling the first circuit board with the second circuit board; and
a hinge section for coupling the first housing with the second housing and capable of folding them,
wherein an antenna section and an element section are disposed at one of the first circuit board and the second circuit board.

2. The portable transceiver of claim 1,
wherein the antenna section and the element section are respectively disposed near two sides, which are opposite to each other, of the circuit board.

3. The portable transceiver of claim 1,
wherein the element section is formed of a pattern on the circuit board.

4. The portable transceiver of claim 1,
wherein the element section is formed of a metal plate.

5. The portable transceiver of claim 1,
wherein a length of the element section is structured so that an electrical length becomes λ/2.

6. The portable transceiver of claim 1,
wherein the antenna section is formed of a helical element and a meander element.

7. The portable transceiver of claim 1,
wherein the antenna section is formed of a plurality of folding type elements to which electric power is supplied.

8. The portable transceiver of claim 1,
wherein the plurality of element sections are formed.

9. The portable transceiver of claim 1,
wherein the element section and the circuit board are coupled with each other via a inductance section.
